(19) United States
(12) Patent Application Publication
(10) Pub. No.: US 2002/0033432 A1
(43) Pub. Date: Mar. 21, 2002

(54) Vehicle seating arrangement

(76) Inventor: Olgierd Stanislaw Mikosza, Alameda, CA (US)

Correspondence Address: LYON & LYON LLP, 633 WEST FIFTH STREET, SUITE 4700, LOS ANGELES, CA, 90071, US

(21) Appl. No.: 09/905,650

(22) Filed: Jul. 13, 2001

(30) Foreign Application Priority Data
Jul. 14, 2000 (ZA) 2000/3540

(51) Int. Cl. B64D 11/06; B64D 13/00

(52) U.S. Cl. 244/118.6

(57) ABSTRACT

A seating arrangement for the passenger compartment of a vehicle such as an airplane in which at least two levels of seating are stacked, with the floor structure between the lower level and the level above it, that is, the upper level in a two-level arrangement, being characterized by alternating raised and lowered sections, such that the seats in the upper level are fastened directly to the raised sections of the floor structure, and the lowered section provides the leg room for the passenger in the upper level seat, the seats on the lower level are arranged so that the lower level seat is underneath the lowered section of the upper level floor structure, and the space between the lower level seats is underneath one of the raised portions of the upper level floor structure so as to create headroom for the lower level passengers. Access to the lower level seats is provided by exterior aisles, and access to the upper level seats is provided by a center aisle. Passenger storage space and transport means can be provided in the center section of the lower level and in the outside ceiling area of the upper level.

### FIELD OF THE INVENTION

This invention relates generally to a multilevel seating arrangement in a vehicle, such as an airplane, which makes efficient use of available space inside the vehicle in order to provide increased passenger comfort without diminishing the passenger-carrying capacity of the vehicle.

### BACKGROUND OF THE INVENTION

As any frequent flyer, or even any not-so-frequent flyer, can attest, the airplane seating in coach class is abominably uncomfortable, while the seating in first class is abominably expensive. It has been reported that the cramped airplane seating is not just uncomfortable, but can be unhealthy as well as lengthy periods of time spent in the typical coach class airplane seat can lead to swelling and blood clotting in the legs.

For these reasons, various attempts have been made to design an improved seating arrangement for airplanes which provide more legroom for the passengers without reducing the number of passengers that can be accommodated within the same fuselage space. For example, in U.S. Pat. No. 5,716,026 (Pascasio et al), a seating arrangement is disclosed in which an elevated row of seats is inserted in between the rows of seats on the floor level. Both the floor-level and elevated rows are accessed by the traditional aisles on the single floor level, with the passengers in the elevated seats having to step up to their seats from the aisle. The passengers in the elevated seats could sit up-right in the usual way, but could extend their legs in a reclining position only by resting their legs on an upper shelf-like area above the floor-level seat in front of them (see FIG. 2).

In U.S. Pat. No. 4,066,227 (Buchsel), a seating arrangement is disclosed in which a narrow mezzanine-level of seats is provided along substantially the entire length of the fuselage of a wide-bodied aircraft, more or less similar to the upper-deck seating that is standard in the Boeing 747 passenger aircraft. Aside from providing the mezzanine level, the seating and mezzanine floor are traditional in nature.

Similarly, in U.S. Pat. No. 5,992,797 (Seidel et al), an upper deck is added to substantially the entire length of the fuselage, essentially by creating another elevated portion of the top of the airplane's fuselage along the back half of the airplane that is similar to that on the front half of a Boeing 747. Aside from adding the second level, however, the seating and floors of the two levels are traditional in design and layout.

In U.S. Pat. No. 6,073,883 (Ohlmann et al), an overhead rest area in an airplane is disclosed in which a mezzanine level is again provided, much as in U.S. Pat. No. 4,066,227 discussed above, but is utilized for individual sleeping compartments.

In U.S. Pat. No. 5,474,260 (Schwertfeger et al), a multi-floor interior for an aircraft is disclosed in which the lower deck can be used for additional seating, convertible beds, rest areas, and the like.

In WO98/35876 (Int'l App. No. PCT/US98/01863)(Bar-Levav), various seating arrangements for an airplane are disclosed. One is a two-level arrangement in which the floor, seats and aisles are of traditional design (see FIG. 2). Another is a stacked seating arrangement in which there are two levels of elevated seats (compared to one level of elevated seats in U.S. Pat. No. 5,716,026 discussed above), that all extend above the traditional single level floor of the passenger compartment (see FIG. 11).

A number of other prior art patents are discussed in the “Background Art” section of WO98/35876. The patents discussed here and there plainly show the long felt need in the art for an improved airplane seating arrangement that not only provides better comfort to the coach class passenger, but does so practically and economically. As these patents also point out, however, accomplishing this trident of goals has proven elusive.

Therefore, there still exists a need in the art for an improved seating arrangement that can provide, in a practical and economical way, greater comfort to passengers not only in an airplane, but in any other vehicle where the space used per passenger is of concern.

### SUMMARY OF THE INVENTION

The invention herein described and claimed provides a vehicle seating arrangement which includes at least a lower seating level and at least an upper seating level located above the lower seating level, an upper floor structure between the lower seating level and at least part of the upper seating level. The upper floor structure is the floor for the upper level and the ceiling for the lower level. When viewed from a side, the floor structure has a corrugated profile or cross-section created by alternating raised portions and lowered portions relative to the centerline of the floor structure. Each of the raised portions simultaneously provides a pedestal to which the upper level seat (without legs) is attached, and a downwardly-facing void space that creates added headroom for the lower level. The lowered portions of the floor structure provide legroom for the upper level seats. The lower level seats are arranged such that they are located beneath the lowered portion of the floor structure. Therefore, the lowered portion is above the lower-level passenger's head when seated (and needs less headroom) and the raised portion is above the passenger's head when he or she stands up (and needs increased headroom).

The seats are accessed by aisles. In the preferred embodiment, the lower level seats are accessed by aisles on the outside of the seating area, and the upper level seats are accessed by a center aisle. The center aisle can extend downwardly into the lower level. Storage space can be added to the space in the lower level below the center aisle in the upper level, and in the area of the upper level above the aisles in the lower level.

In another embodiment, the storage space may be divided by partitions which permit access to the storage space in an alternating sequence from respective opposed sides in the lower seating level.

In yet another embodiment, a transport device may be positioned below the upper floor structure, preferably below the aisle in the upper seating level, to transport goods such as food trays or beverages to or from the passengers. The transport device may be in the nature of a conveyor belt. Similar transport devices may be positioned above lower seating level aisles and above or below upper seating level storage spaces.

The benefits to be derived from this invention are several. All passengers on the plane, not just those in first class, will have the comfort (and reduced chance of health problems) of wider seats, more leg room, and if desired, fully-reclining seats. There are more and larger aisles servicing the same number of passengers so that ingress and egress are facilitated. More doors can be placed in the plane fuselage without sacrificing the economics of the plane load, which will further facilitate ingress and egress. This will allow the plane to be loaded and unloaded more quickly, which will decrease total trip turnaround time. The improved egress and would be particularly helpful in an emergency situation. By placing another structural element having a corrugated configuration (that is, the upper floor structure) within and across the fuselage, the overall structural integrity of the plane is enhanced. Economic benefits include being able to offer all passengers superior comfort at reasonable fares while at the same time increasing total passenger fare revenues. These and other benefits flow directly from this invention.

As used herein the word “vehicle” relates to any passenger transport vehicle, including but not limited to aircraft, and in particular wide-bodied types of aircraft. The invention is described hereinafter with reference to an aircraft but is to be understood that this is only by way of example and that the scope of the invention, while perhaps finding its greatest utility in aircraft, is not limited to this specific application.

### BRIEF DESCRIPTION OF THE DRAWINGS

The invention is further described by way of example with reference to the accompanying drawings in which:

FIG. 1 is a somewhat schematic side view of a wide-bodied aircraft which includes a multi-level seating arrangement according to one form of the invention,

FIG. 2 is an enlarged view from the side, in cross-section, of a portion of the aircraft of FIG. 1 showing business class seating on a lower seating level and on an upper seating level,

FIG. 3 is a cross-sectional view, on an enlarged scale, of the aircraft taken on a line 3-3 in FIG. 1,

FIG. 4 is a view similar to FIG. 2 but showing tourist seating on upper and lower seating levels,

FIG. 5 is a view similar to FIG. 3 but taken on a line 5-5 in FIG. 1, and

FIG. 6 is a plan view of a portion of the aircraft showing business class seating, and a storage arrangement, available to passengers on a lower seating level of the aircraft.

### DESCRIPTION OF PREFERRED EMBODIMENT

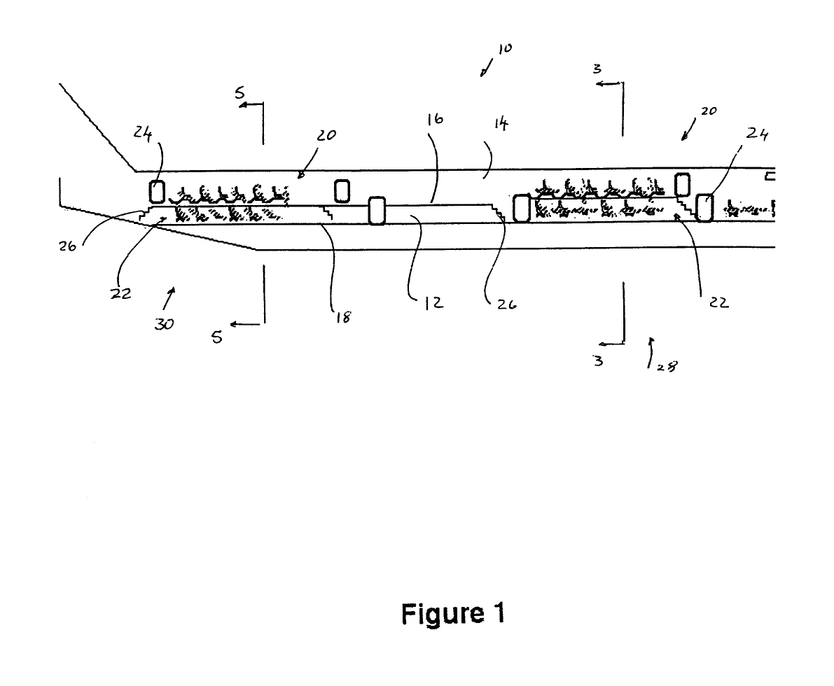

FIG. 1 of the accompanying drawings illustrates an aircraft 10 which is a wide-bodied aircraft and which includes a lower seating level 12, an upper seating level 14, an upper floor structure 16 between the levels 12 and 14, a lower floor structure 18 for the lower seating tierl 12, a plurality of seats 20 in the upper seating level 14, and a plurality of seats 22 in the lower seating level 12.

Doors, hatches and windows, generally designated 24, are positioned at various locations on or in the aircraft. This aspect is of course known and consequently is not further elaborated on herein. Staircases and stairwells, generally designated 26, are provided at different locations inside the aircraft to provide access between the lower and upper seating levels 12 and 14.

The forward section of the aircraft illustrates business class seating 28 in the lower and upper seating levels while, at a rear end of the aircraft, tourist class seating 30 is provided.

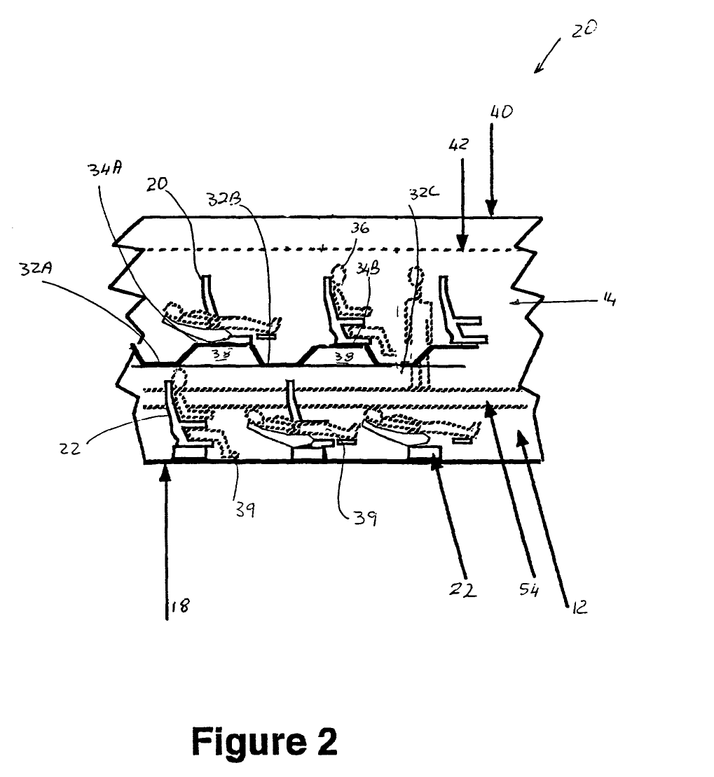

FIG. 2 is a side view, in enlarged detail, of the forward portion of the aircraft which includes business seating.

The upper floor structure 16 has a corrugated profile or cross-section and includes a plurality of lowered floor sections 32A, 32B, 32C etc. and a plurality of raised seat sections 34A, 34B, 34C etc. which are raised relatively to the respective floor sections. The seats 20 in the upper seating level 14 are mounted directly, (ie. the seats do not have legs), to the respective raised seat sections 34. Legs on the seats can be dispensed with for the seating height is obtained by the difference in height between the floor sections 32 and the seat sections 34. The seats are positioned so that a passenger (designated 36) on a seat can use the space provided by the difference in height between the raised seat section 34 and a respective floor section 32, to accommodate his feet and a portion of his legs.

The seats 22 on the lower floor structure 18, inside the lower seating level 12, are staggered relatively to the seats 20 in the upper seating level 14. It is apparent from an examination of FIG. 2 that the raised seat sections 34 define downwardly facing voids 38. The arrangement is such that the voids 38 form volumes of increased headroom for the passengers, designated 39, on the seats 22 in the lower seating level 12.

The spacing between adjacent rows of the seats 20 in the upper seating level 14, viewed from the side, is such that the seats can be fully reclined to afford each passenger the opportunity of resting substantially horizontally without interfering with adjacent passengers. A similar facility is afforded to the passengers on the seats 22 in the lower seating level 12.

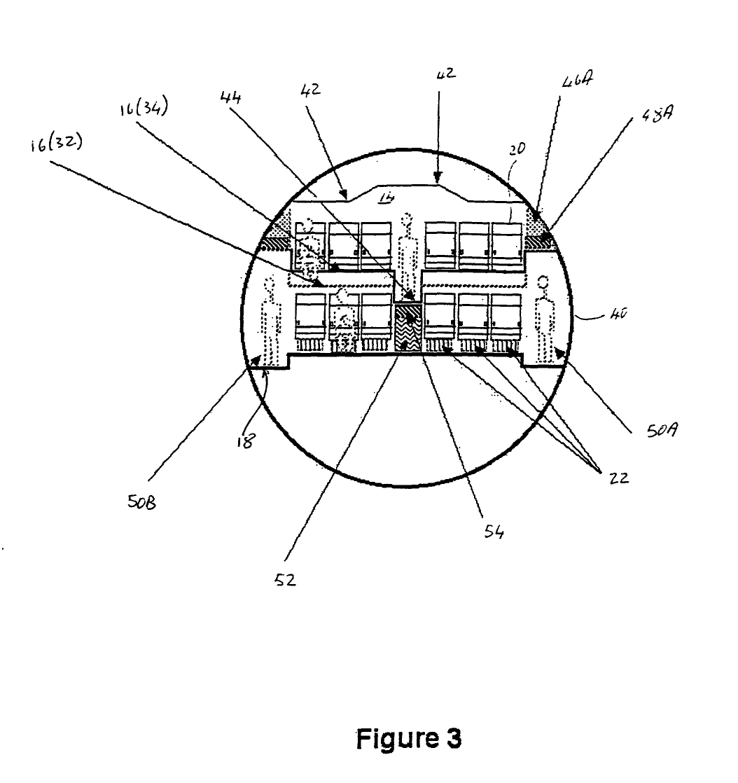

FIG. 3 is a cross-sectional view through the seating arrangement shown in FIG. 2. This Figure illustrates the fuselage 40 of the aircraft and a ceiling 42 above the upper seating level 14. The upper floor structure 16 is shown in solid and dotted lines. The solid lines designate the raised seat sections 34 while the dotted lines designate the lower floor sections 32.

An aisle 44 extends through the upper seating level and is positioned between the seats 20, dividing the seats into banks or groups. The aisle 44 may be placed slightly lower, in this instance, than the floor sections 32. This means that a person may have to climb a step in going onto a floor section. Luggage storage spaces 46A and 46B are provided on opposed sides of the aircraft, extending in the longitudinal direction. The storage spaces 46 are for the use of passengers in the upper seating level. Optionally, below the respective storage spaces, conveyor belts 48A and 48B are installed. These belts extend the length of the seating section, in the upper seating level, and are used for conveying food or beverages to the passengers in the seats 20. The belts are also used for removing unwanted articles such as trays, mugs and the like from these passengers.

In the lower seating level 12 aisles 50A and 50B respectively are provided at locations which are adjacent inner wall surfaces of the fuselage. It is apparent that the seats 22 on the lower floor structure 18 do not extend to the side walls, as is commonly the case. As is shown in FIG. 3 parts or all of the aisles 50 may be placed a step below the foot level of the lower seating level passengers. This arrangement provides increased headroom for persons using the aisles 50. A storage volume 52 is defined between the seats 22 which are divided into two groups. A conveyor belt 54 is positioned above the storage volume. The conveyor belt 54 is similar to the belts 48 used in the upper seating level and may extend for most or all of the length of the aisle 44 to provide a means for conveying food and beverages to the passengers on the seats 22 and for removing trays, mugs and the like from these passengers.

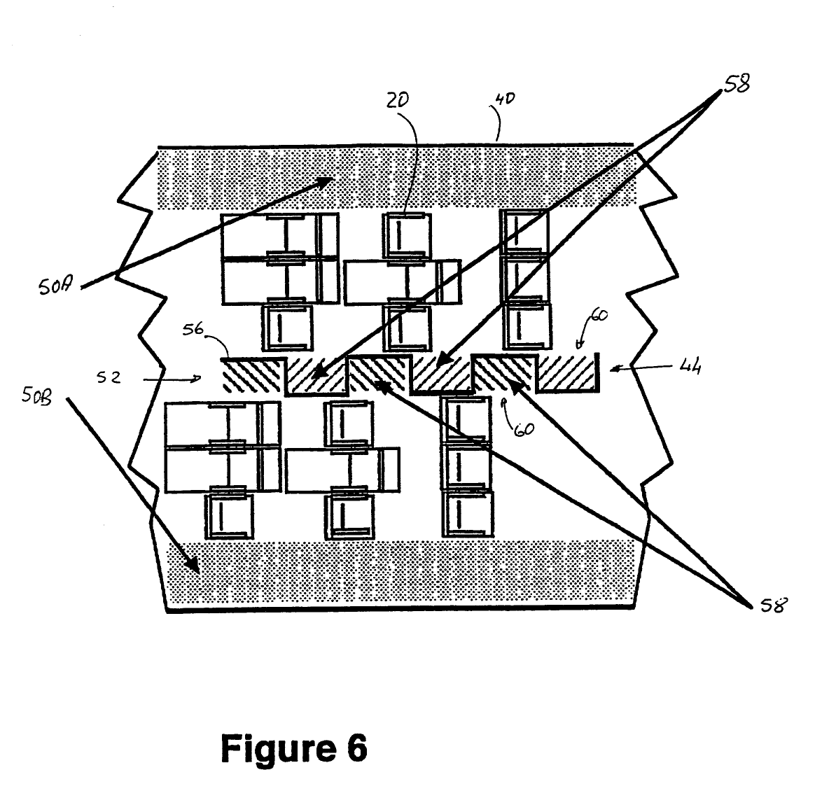

FIG. 6 is a plan view taken on the line 6-6 of FIG. 3 and illustrates the way in which the storage area 52 is configured. A partition 56 divides the storage volume into a plurality of cubicles 58. Viewed in plan the partition has the profile of a square wave and consequently the cubicles 58 can be accessed from opposing sides through entry hatches 60 in an alternating array. The partition is below the aisle 44 and the belt 54. Thus the partition rigidifies the underlying support structure for the belt 54 and the aisle 44 above it as well as for the whole of the upper floor structure.

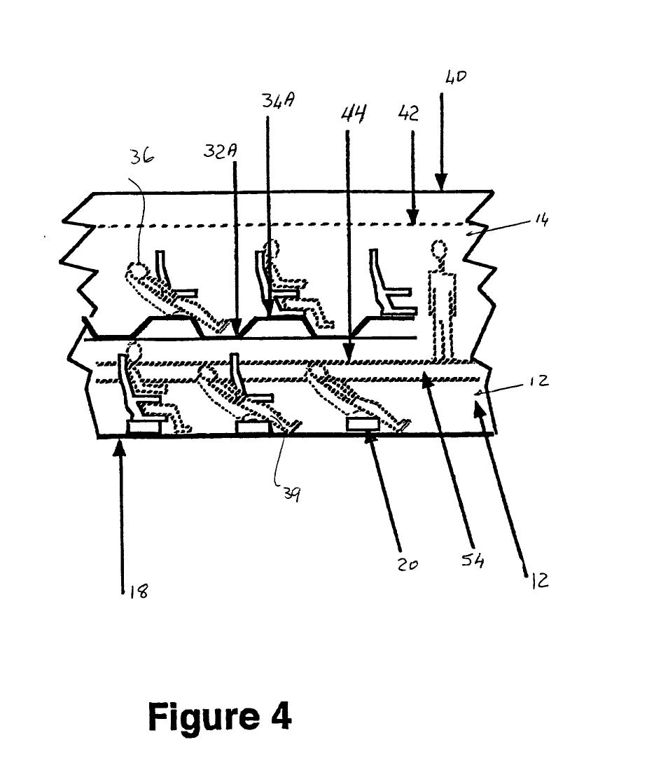

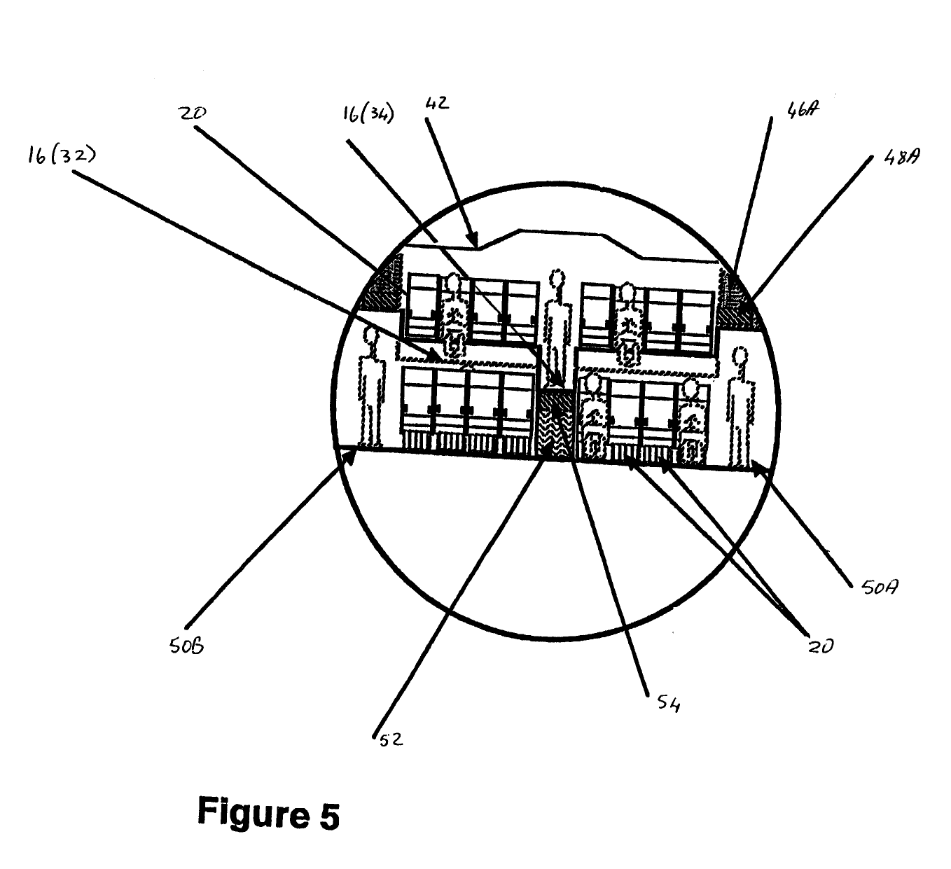

FIGS. 4 and 5 are substantially similar to FIGS. 2 and 3 but illustrate tourist class seating on the lower and upper seating levels 12 and 14 of the aircraft. Where applicable components in FIGS. 4 and 5 which are similar to components in FIGS. 2 and 3 bear similar reference numerals.

It is apparent that the seats in FIGS. 4 and 5 may be packed in a greater density and may be smaller than the seats in the business class accommodation but may be bigger and wider than those currently used in tourist sections. Nonetheless the principles of constructions are similar and, as before, the passengers in the upper seating level 14 have a aisle 44 while the passengers in the lower seating level 12 have at least two outer aisles 50A and 50B respectively.

Apart from the seats being packed closer to one another in a transverse direction the seats, viewed from the side, may be placed closer to one another than the seats in the business section, if the currently used passenger capacities in tourist section are to be retained. Thus, as is shown in FIG. 4, the seats when moved to a reclining position may not be substantially horizontal but may be inclined. Consequently the passengers may not lie horizontally when resting but may lie, instead, in inclined positions. Nonetheless the benefits which are obtained in the tourist class accommodation are similar to the benefits which are obtained in the business section. These benefits include better space utilisation which results in increased space for passengers and a greater level of comfort.

In order to achieve the current capacity in the tourist section the rows or seats in this section may be spaced at approximately 70% to 80% of the space which is envisaged for the business section. As noted, although this spacing may not be sufficient to allow for a fully horizontal reclined position it will still allow for a passenger to be fully stretched, although inclined.

At the same time, capacity for the business section can be approximately doubled, as compared to the currently used arrangements.

The inclined surfaces of the upper floor structure, formed by sides of seat sections which face the respective seats, can be used for the mounting of in-flight entertainment screens, if required.

A further benefit of the invention is related to the ability to place handles or railings in the lower ceilings, which are then within easy reach, so as to assist passengers crossing adjacent seating spaces of other passengers and thus improving safety during motion of the vehicle, while at the same time avoiding the need to grab other seats, which can be annoying and cause discomfort to others.

It is apparent that the invention is not limited to the seat and row layout described hereinbefore and shown in the drawings. Depending on the aircraft type and size, and on operational or commercial requirements such as seat width and spacing, it is possible to utilize a different number of adjacent seats and/or greater number of aisles on the upper and lower seating levels.

Therefore, the invention hereinafter claimed is not limited to the embodiments described above, but is of the full breadth and scope of the following claims.

What is claimed is:

1. A vehicle seating arrangement in which two levels of seats, a top level and a bottom level, are arranged one over the other separated by a floor structure, with the seats on said bottom level being arranged in rows accessed by outside aisles, there being a center space in each row between adjacent seats in that row that is not occupied by a seat; the seats on said top level being arranged in rows accessed by a center aisle, said center aisle being located above and extending into said center space in said bottom level; said floor structure having a corrugated shape characterized, when viewed from the side, by interspersed raised portions and lowered portions, in which said seats on said upper level reside on said raised portions, and said lowered portions provide the leg room between adjacent seats on said upper level; the seats on the bottom level being arranged such that at least some of the seats are positioned directly below said lowered portion of said floor structure, and the leg room space between seats on the bottom level being located directly below said raised portion of said floor structure so as to provide headroom for the bottom level passenger when he or she stands up.

2. The vehicle seating arrangement of claim 1 in which one or more levels of seats are added above the two levels in a stacked fashion, with the first additional level having seats arranged in rows accessed by outside aisles, and the floor structure of said first additional level having a corrugated shape characterized, when viewed from the side, by interspersed raised portions and lowered portions, in which said seats reside on said raised portions, and said lowered portions provide the leg room between adjacent seats; said raised portion being arranged such that it is immediately above the legroom space between seats on the level immediately below it so as to provide headroom for the passenger.

3. The vehicle seating arrangement of claim 1 designed and constructed to fit within an airplane fuselage, with access to said aisles being provided to and from the doors in said airplane fuselage used for passenger ingress and egress.

4. The vehicle seating arrangement of claim 3 in which said outside aisles on said bottom level are located adjacent the airplane fuselage walls.

5. The vehicle seating arrangement of claim 1 in which there are multiple seats in each said row.

6. The vehicle seating arrangement of claim 3 in which there are multiple seats in each said row.

7. The vehicle seating arrangement of claim 1 in which the area in said center space of said bottom level is used for storage space for passengers in said bottom level.

8. The vehicle seating arrangement of claim 3 in which the area in said center space of said bottom level is used for storage space for passengers in said bottom level.

9. The vehicle seating arrangement of claim 1 in which transport means are housed in a portion of said center space.

10. The vehicle seating arrangement of claim 3 in which transport means are housed in a portion of said center space.

11. The vehicle seating arrangement of claim 1 in which passenger storage space is provided for passengers in said upper level seats along the walls of the vehicle above said lower level aisles.

12. The vehicle seating arrangement of claim 3 in which passenger storage space is provided for passengers in said upper level seats along the walls of the vehicle above said lower level aisles.

13. The vehicle seating arrangement of claim 11 in which transport means are housed adjacent to said storage space.

14. The vehicle seating arrangement of claim 12 in which transport means are housed adjacent to said storage space.

15. A passenger seating arrangement in a vehicle comprising:
a. a lower level having seats attached to a floor;
b. an upper level having seats attached to a floor structure;
c. said upper level floor structure having a substantially corrugated cross-sectional configuration comprising raised portions and lowered portions relative to the longitudinal centerline of said floor structure;
d. said seats on said upper level attached to said raised portions; and
e. said seats on said lower level arranged such that one or more of the seats are attached to said lower level floor at a position below said lowered portion of said upper level floor structure.
